(19) United States
(12) Patent Application Publication
(10) Pub. No.: US 2013/0163780 A1
(43) Pub. Date: Jun. 27, 2013

(54) METHOD AND APPARATUS FOR INFORMATION EXCHANGE BETWEEN MULTIMEDIA COMPONENTS FOR THE PURPOSE OF IMPROVING AUDIO TRANSDUCER PERFORMANCE

(71) Applicants: John Alfred Blair, Atherton, CA (US); Kimbal Collin Wallace Ryrie, Woollahara (AU)

(72) Inventors: John Alfred Blair, Atherton, CA (US); Kimbal Collin Wallace Ryrie, Woollahara (AU)

(21) Appl. No.: 13/727,570

(22) Filed: Dec. 26, 2012

Related U.S. Application Data
(60) Provisional application No. 61/631,051, filed on Dec. 27, 2011.

(51) Int. Cl. H04R 3/12

(52) U.S. Cl. CPC H04R 3/12
USPC 381/77

(57) ABSTRACT

A system and method for utilizing a plurality of Transducer specification files (TSFs) stored in one or more TSF databases to configure a Transducer Correction Processor (TCP). An incoming audio stream from an audio signal source is provided to the TCP, with the TCP using the unique configuration of the Transducer (e.g., speaker) contained in the TSF, applies corrections to the audio stream to produce a corrected audio stream. The corrected audio stream compensates for temporal or frequency domain or other aberrations produced by the particular Transducer. Consequently, a sound field produced by the Transducer from the corrected audio stream is close to or identical to a sound field produced by a “perfect” Transducer from the incoming audio stream.

### RELATED APPLICATIONS

This application is a Continuation-in-Part of U.S. Provisional Application Ser. No. 61/631,051 for METHOD AND APPARATUS FOR INFORMATION EXCHANGE BETWEEN MULTIMEDIA COMPONENTS FOR THE PURPOSE OF IMPROVING AUDIO TRANSDUCER PERFORMANCE, filed Dec. 27, 2011 and claims priority thereto in accordance with 35 U.S.C. §119(e), and which is included herein in its entirety by reference.

### FIELD OF THE INVENTION

The invention pertains to correction of audio signals in the time and/or frequency domain and, more particularly, to applying corrected (i.e., compensated) signals to acoustical Transducers to overcome linear errors of amplitude (i.e., frequency response errors) and timing coherence (i.e., group-delay errors) generated by the acoustical Transducers.

### BACKGROUND OF THE INVENTION

Loudspeakers, and the various component Transducers that are also commonly known as drivers, namely bass frequency drivers, midrange frequency drivers, and high frequency drivers or tweeters, that are combined within them, are generally considered the weakest link in audio systems. One of the most common types of driver is a dynamic speaker. Dynamic speakers utilize a lightweight diaphragm, or cone, connected to a rigid basket, or frame, via a flexible suspension (e.g., a spider) that constrains a coil of fine wire to move (i.e., the voice coil) axially through a cylindrical magnetic gap, and a second flexible suspension source at the distal end of the cone from the voice coil.

When an electrical signal is applied to the voice coil, a magnetic field is created by the electric current in the voice coil, making it a variable electromagnet. The coil and the driver's magnetic system interact, generating a mechanical force that causes the voice coil and, in turn, the attached cone to move back and forth in response to the electrical signal applied to the voice coil. The back and forth movement of the cone coupled with the cone's boundary layer of air transmits a sound analogous to the signal applied to the voice coil. This process reproduces a sound corresponding to the electrical signal provided, typically from an amplifier.

A dynamic speaker is effectively a linear motor having a cone that is moved back and forth by the interaction of an electromagnetic field and a stationery magnetic field surrounding the voice coil. For myriad reasons, the sound reproduced by the speaker cone is typically not an exact replica of the electrical signal applied thereto. Such reasons are well known to those of skill in the design of acoustical Transducers. Modern loudspeakers incorporate designs and materials to minimize the nonlinearity between the applied electrical signals and the sounds produced by the speaker cones. While modern speakers do a reasonable job of reproducing sound corresponding to an applied electrical signal, they are far from perfect.

The problems responsible for the differences between the applied electrical signals and the sound output by individual Transducers are caused by the Transducers' introduction of errors—such as frequency-related linear errors of amplitude (frequency-response errors) and phase, or timing coherence (group-delay errors). These errors may be one to two orders of magnitude greater than are found in the signal driving the loudspeakers, generally because of the mechanical nature of loudspeaker Transducers. Furthermore, non-linear errors cause distortions of various kinds due to Transducer “breakup” modes and unwanted interactions between Transducers introduced by crossover networks that attempt to direct certain ranges of frequencies to the appropriate driver. Crossovers split the audio signal into separate frequency bands that are separately routed to Transducers optimized for those bands. All such distortions dramatically reduce the overall reproduction by a loudspeaker system of the original applied electrical signal.

However, the measurement of the characteristics of a particular Transducer to produce a Transducer specification file (TSF) for that Transducer (necessary to configure a Digital Signal Processor (DSP) to correct for the unwanted characteristics of that Transducer) is a complex and time consuming task that currently must be performed by an end user or a trained installation engineer. As a consequence, it is typically done only for relatively high end Transducers and systems, even though DSP correction can provide great benefit across the range of low-end to high-end systems.

### DISCUSSION OF THE RELATED ART

The following patents describe various sound Transducer correction systems and devices. Citation thereof is not an admission that any of these are prior art to the instantly claimed invention nor is the citation of this listing an acknowledgement that an exhaustive search has been completed.

U.S. Pat. No. 7,580,530, issued Aug. 25, 2009 to Konagai, et al., for AUDIO CHARACTERISTIC CORRECTION SYSTEM, discloses an audio characteristic correction system adapted to an audio surround system in which a sound emitted from a directional speaker (an array speaker) is reflected on a wall surface or a sound reflection board so as to create a virtual speaker, at least one of frequency-gain characteristics, frequency-phase characteristics, and gain of an audio signal input to the directional speaker is corrected such that the sound reflected on the wall surface or the sound reflection board has desired audio characteristics at a desired listening position.

U.S. Pat. No. 8,300,837, issued Oct. 30, 2012 to Shmunk, for SYSTEM AND METHOD FOR COMPENSATING MEMORYLESS NON-LINEAR DISTORTION OF AN AUDIO TRANSDUCER, discloses a low-cost, real-time solution for compensating memoryless non-linear distortion in an audio Transducer. The playback audio system estimates signal amplitude and velocity, looks up a scale factor from a look-up table (LUT) for the defined pair (amplitude, velocity) (or computes the scale factor for a polynomial approximation to the LUT), and applies the scale factor to the signal amplitude. The scale factor is an estimate of the Transducer's memoryless nonlinear distortion at a point in its phase plane given by (amplitude, velocity), found by applying a test signal having a known signal amplitude and velocity to the Transducer, measuring a recorded signal amplitude and setting the scale factor equal to the ratio of the test signal amplitude to the recorded signal amplitude. Scaling can be used to either pre- or post-compensate the audio signal, depending on the audio Transducer.

U.S. Pat. No. 7,391,872, issued Jun. 24, 2008 to Pompei, for PARAMETRIC AUDIO SYSTEM, discloses a parametric audio system having increased bandwidth for generating airborne audio signals with reduced distortion. The parametric audio system includes a modulator for modulating an ultrasonic carrier signal with a processed audio signal, a driver amplifier for amplifying the modulated carrier signal, and an array of acoustic Transducers for projecting the modulated and amplified carrier signal through the air along a selected projection path to regenerate the audio signal. Each of the acoustic Transducers in the array is a membrane-type Transducer. Further, the acoustic Transducer array is a phased array capable of electronically steering, focusing, or shaping one or more audio beams.

U.S. Pat. No. 4,868,476, issued Sep. 19, 1989 to Respaut, for TRANSDUCER WITH INTEGRAL MEMORY, discloses a memory means that is adapted to be mounted integral with the Transducer element used in a Transducer system. The memory may store nonlinearity error information or other information concerning errors in the positioning or scan control for the particular Transducer, which information may be utilized by the Transducer system to compensate for such errors. The memory may also be utilized to store selected information concerning the measured output characteristics of the Transducer element, which may then be utilized by the Transducer system to assure that a desired output level is achieved from the Transducer element or that the output otherwise is in conformance with that desired. One or more bytes may be provided in the memory, which may be utilized to inhibit use of the associated Transducer element for particular fields of use or classes of service. The memory element may also store other selected information concerning the particular Transducer element, including various operating constants for the element, which information may be utilized by the Transducer system to control the operation of the Transducer element, to evaluate responses obtained from the Transducer, for service, or for other selected purposes. If an erasable memory is used, an area of the memory may also be utilized to store information concerning the operation of the Transducer element, such as its duration of use, which information is periodically updated in the memory by the processor.

U.S. Pat. No. 8,121,302, issued Feb. 21, 2012 to Skuruls, for METHOD OF CORRECTION OF ACOUSTIC PARAMETERS OF ELECTRO-ACOUSTIC TRANSDUCERS AND DEVICE FOR ITS REALIZATION, discloses a device and method for improving the performance of an electro-acoustic Transducer. An acoustic test signal is generated through the electro-acoustic Transducer. The acoustic test signal is measured at multiple points on an ambient surface around the electro-acoustic Transducer to create measured acoustic data. Based on the measured acoustic data, an acoustic power frequency response of the electro-acoustic Transducer is calculated. A correction impulse response for the electro-acoustic Transducer is determined based on the acoustic power frequency response. A correction filter applies the correction impulse response to a sound signal input to generate a sound signal output for playback through the electro-acoustic Transducer.

None of the patents, taken singly, or in any combination, are seen to teach or suggest the novel method of correcting an audio stream for the known errors of specific Transducers or systems of Transducers of the present invention.

### SUMMARY OF THE INVENTION

In accordance with the present invention there is provided a system and method for utilizing a plurality of Transducer specification files (TSFs) stored in one or more TSF databases to configure a Transducer Correction Processor (TCP). An uncorrected audio stream from an audio signal source is provided to the TCP. Using the unique configuration for the Transducer (e.g., speaker) contained in the TSF, the TCP applies corrections to the audio stream to produce a corrected audio stream. The corrected (i.e., compensated) audio stream compensates for temporal or frequency domain or other aberrations produced by the particular Transducer. Consequently, a sound field produced by the Transducer from the corrected audio stream is close to or identical to a sound field produced by a “perfect” Transducer from the uncorrected audio stream.

TSFs may be designed to apply to a class of Transducers, or to Transducers of a particular manufacturer and/or model number, or alternately, a TSF may be developed that applies only to a single specimen of a Transducer from a particular manufacturer. It will be recognized that the more precise the TSF, the relatively better job of correction may be done in creating a corrected audio stream.

It is, therefore, an object of the invention to provide a mechanism by which a Digital Signal Processing (DSP) system may be configured to enhance the effective sound quality of an individual sound Transducer or group of sound Transducers by correcting an audio stream feed, and thereto to overcome known errors in the Transducer or Transducers.

It is another object of the invention to provide a process by which a DSP, or a general purpose (CPU) as used in a personal computer (PC), a mobile device such as a Smartphone, a tablet computer, etc., any of which are capable of being programmed to perform digital signal processing may be configured for real-time compensation of loudspeaker deficiencies using a correction processor engine and correction rules related to a particular loudspeaker.

It is yet another object of the invention to provide an audio signal source such a general purpose (CPU) as used in a personal computer (PC), a mobile device such as a Smartphone, a tablet computer, etc., that additionally provides DSP functionality.

It is a still further object of the invention to enable the DSP configuration to be carried out automatically, with no or very few tasks to be performed by the end user.

It is an additional object of the invention to provide an audio signal pre-processor for fitment during initial loudspeaker manufacturing whereby the DSP correction system is unified with the loudspeaker and factory installed.

It is another object of the invention to provide a system wherein all necessary hardware and software to accomplish DSP correction of a particular Transducer or Transducer system is housed in an enclosure with the Transducer or Transducer system to provide a self contained Transducer system.

It is an additional object of the invention to provide a system wherein groups of Transducers having similar performance characteristics may be fed a corrected audio stream from a single common DSP.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a simplified block diagram of a TSF database and a TSF interface manager (TIM) in accordance with the invention;

FIG. 2a is a simplified system block diagram of a high definition audio apparatus with system components interconnected using Point-to-Point (P2P) connections;

FIG. 2b is a simplified block diagram of an alternate embodiment of a high definition audio apparatus wherein system components are interconnected by LAN- or WAN-based interconnections;

FIG. 3 is a simplified flow chart of the correction process in accordance with the invention for a high definition audio apparatus having a single Transducer;

FIG. 4 is a simplified flow chart of the correction process in accordance with the invention for a high definition audio apparatus having multiple Transducers;

FIG. 5 is a simplified schematic system block diagram of a high definition audio apparatus incorporating LAN/WAN interconnections and a digital interface to the Active Transducer;

FIG. 6 is a simplified schematic system block diagram of a high definition audio apparatus incorporating LAN/WAN interconnections and an analog interface to the Passive Transducer;

FIG. 7a is a simplified schematic system block diagram of a high definition audio apparatus an internally stored TSF therewithin;

FIG. 7b is a simplified schematic system block diagram of a high definition audio apparatus incorporating all system components within a single physical entity;

FIG. 8a is a simplified system block diagram of a system having numerous similar Transducers feed a single corrected audio stream; and

FIG. 8b is a simplified system block diagram of the system of FIG. 8a but with two different types or models of Transducer, each type of Transducer being fed a differently corrected audio stream.

### DETAILED DESCRIPTION OF THE EMBODIMENT

The present invention provides method and apparatus for providing corrections to an audio signal to compensate for both frequency and time distortion inherent in most if not all loudspeaker systems.

Several terms used herein are first defined.

### Passive Transducer

A passive audio Transducer (hereinafter, a “Passive Transducer”) converts an analog electrical signal into acoustic energy so that the resulting sound may be heard by one or more listeners. Examples of Passive Transducers include loudspeakers and headphones. A Passive Transducer may be combined with other elements (e.g., a microphone), so as to be used for enhanced applications e.g., as a telephone headset.

Because a Passive Transducer relies on an incoming audio signal for the energy necessary to create the desired acoustic energy, the power of that signal must be sufficient for that purpose. Such a signal is generally referred to as a “high level signal”.

The Passive Transducer may consist of a single Transducer element, or of multiple individual Transducer elements combined into an integrated whole. For example, two Transducer elements may be combined into a single headphone Transducer so as to make a stereo headphone.

Alternatively, or in addition, individual signals may be inputted to separate Transducers designed to handle different parts of the audio spectrum (e.g., separate low, mid-range, and high frequency signals) either directly or using a crossover network. Accordingly, the term Passive Transducer is used herein to refer to a system comprising one or more individual Passive Transducers (i.e., drivers).

### Active Transducer

In certain multimedia architectures it is desirable to combine a Passive Transducer with an amplifier capable of delivering the energy necessary to create the desired acoustic energy into a single package. Such a package is hereinafter referred to as an Active Transducer. In such an architecture, only low-level audio signals need be inputted into the Active Transducer, although in certain embodiments a high-level signal may be accepted and internally transformed to the level necessary to feed the embedded amplifier.

As with a Passive Transducer, an Active Transducer may consist of a single Transducer element, such as a monaural powered sub-woofer, or may consist of multiple individual Transducers combined into an integrated system (e.g., a multi-channel, integrated, self-powered speaker system). Accordingly, the term Active Transducer as used herein refers to a system comprising one or more of such individual Active Transducer elements, where each type of element (e.g., bass driver, midrange driver, and tweeter driver) may be driven by a separate power amplifier. In such an arrangement, low signal level crossover filters may be utilized prior to each power amplifier thereby avoiding the requirement for traditional “passive” crossover filters. This allows, for example, two-way, three-way, or four-way active driver configurations by providing a separate TSF for each amplification/driver combination.

### Analog Audio Stream

An analog audio signal, either high-level or low-level, is fed into a Passive or Active Transducer, respectively, to drive that Transducer. A Passive or Active Transducer system made up of multiple individual Transducers may allow the inputting of multiple separate signals (e.g., a left and right channel signal for a stereo Transducer). The combination of one or more individual audio signals necessary to drive a Passive or Active Transducer is hereinafter referred to as an “Audio Stream”. When those signals are analog audio signals, that audio stream is referred to as an “Analog Audio Stream”.

### Digital Audio Stream

Alternatively, Active Transducers may be designed to accept audio signals encoded according to one or more digital signal standards (e.g., the Sony/Philips Digital Interconnect Format (SPDIF) standard, etc.). Again, such digital signals may allow the combination of multiple individual signals (e.g., for left and right channels, or for low- and high-frequency sounds). When one or more signals are digitally encoded, that audio stream is referred to as a digital audio stream.

Such a digital audio stream may itself be part of a broader multimedia data stream that may also contain other information elements (e.g., video information, or sub-title information). For example, the High Definition Multimedia Interface (HDMI) standard contains digital video and security data as well as a digital audio stream. Alternatively, a digital audio stream may be part of a broader stream that also contains an analog audio stream, thereby allowing connection to a broader range of Passive or Active Transducers.

In commonly assigned U.S. Pat. No. 7,333,539 for HIGH ORDER FILTERS WITH CONTROLLABLE DELAY AND PERFORMANCE, issued Feb. 19, 2008 to Paul William Glendenning, there is shown a process whereby an audio stream may be manipulated in such a way as to produce an output stream that is modified so as to correct any errors and distortions that would otherwise be created by the specific characteristics of a Transducer. Uncorrected, these characteristic Transducer errors and distortions may be a substantial source, frequently the dominant source, of the total audio system output errors and distortion. Correcting these errors improves the audio quality of the sound reproduction when that audio stream is reproduced through the Passive Transducer. Note that U.S. Pat. No. 7,333,539 is incorporated herein in its entirety by reference and is hereafter referred to as “GLENDENNING”.

Such correction may be performed to several degrees of precision. For example, correction may be performed such that it is tailored for a general class of Passive Transducers, such as in-ear audio headphones. A more precise correction may be tailored to a specific model of Active or passive Transducer, such as a specific brand and model of loudspeaker. At still more precision, correction may be tailored to a specific instance of a specific model of an Active or Passive Transducer, such as an individual manufactured unit of a particular brand and model of loudspeaker. It will be recognized that corrections may also be performed at intermediate degrees of precision between, or at levels of precision outside, the range of precision chosen for purposes of disclosure. Consequently, the invention is not considered limited to a particular degree of correction precision. Rather the invention is intended to cover any degree of precision.

The conversion of an incoming audio stream to a corrected (i.e., compensated) output audio stream as described above will be hereinafter referred to as “Transducer Correction Processing”. A corrected audio stream that is the result of that processing is hereinafter referred to as a “Corrected Audio Stream.” The component or system that performs such conversion is hereinafter referred to as a “Transducer Correction Processor” (TCP).

A TCP may be implemented as a dedicated device, for example, one of the HDP-x Series Loudspeaker Correction Processors, as provided by DEQX Pty Ltd of Sydney, New South Wales, Australia. Software implemented TCP correction systems may be included as part of more general purpose hardware. Examples of general purpose hardware include, but are not limited to, portable music players (e.g., “MP3” players), cellular phones or similar communications devices, tablet computers, notebook or desktop computers, and other such equipment potentially used to reproduce music.

The TCP operates using a data set that characterizes the nature of the conversion that should be applied to an input audio stream so as to produce a corrected audio stream that is appropriate for (i.e., compatible with) the characteristics of the Transducer being driven.

In one embodiment, such a dataset might, for example, specify the audio characteristics of the Transducer, such that the TCP analyzes the appropriate Transducer characteristics to develop an appropriate signal processing algorithm to create the corrected stream.

In another embodiment, the dataset might specify the various parameters for such a signal processing algorithm.

Other embodiments are possible. As previously discussed, such a dataset may be developed at one or more levels of precision (e.g., for a class of Transducers, for a specific Transducer model, or for a specific sample of such a model). Such a dataset is hereinafter referred to as a “Transducer Specification Dataset.”

### Audio Source

An element that creates an audio stream for delivery to a Passive or Active Transducer is hereinafter referred to as the “Audio Source.” An Audio Source may have many embodiments. Such an Audio Source may retrieve an audio stream from a source such as a CD or an MP3 file, and convert that data into an audio stream. Alternatively, an Audio Source may accept an audio stream from another device, such a CD or MP3 player, and process that audio stream in some way before delivering it to the Passive or Active Transducer(s).

Connection mechanisms between an Audio Source and a Passive or Active Transducer may be implemented in many ways. For example, an Audio Source may be connected to an Active Transducer over a communications link designed for point to point communications. That is, the Audio Source may be connected to the Active Transducer over a serial communications interface such as a USB connection. Alternatively, such a connection may be implemented using a wireless link, such as through a device in accordance with Apple's Airplay® standard. Such a point-to-point connection is hereinafter referred to as a “P2P Communication Link.”

A P2P communication link may also be used to connect a TCP to an Active Transducer, or to connect an Audio Source to the TCP. Note that a P2P communication link may be internalized within a device made up of one or more of these elements. A device, for example, that combines a TCP and an Audio Source might use an internal P2P communication link to interconnect those elements.

Alternatively, two or more Audio Sources and Transducers may be connected over a wireless or wired local area network (“LAN”) communications infrastructure. For example, an Audio Source and an Active Transducer may each register as a node or device on the LAN, allowing mutual discovery and communication of audio streams and other information. Such a connection will be hereinafter referred to as a “LAN Communication Link.”

LAN communications may be extended over a wider area, so that devices not on the same LAN can communicate with one another. One common way to implement such a connection is over the Internet. Such a connection is hereinafter referred to as a Wide Area Network or “WAN Communications Link.” It should be recognized that an Internet connection may involve any combination of wired and wireless communications elements.

The present invention has several components required to provide a corrected audio stream for a particular Active or Passive Transducer. First, a Transducer Specification File (TSF) containing a TSF identifier and a collection of Transducer correction information, (e.g., the Transducer Correction Dataset) previously mentioned is needed.

As previously explained, a TSF may be specific to a class of components (i.e., Transducers), or to a specific Transducer model, or to a specific instance (i.e., a particular specimen) of a particular Transducer model. The TSF may be stored in any of a multiplicity of digital media, for example, RAM, permanent storage such as disk, on a flash memory device, etc. The invention is not considered limited to a particular storage device or medium upon which a TSF is stored.

The TSF may also contain other information useful for the configuration of an audio system, for example the frequency band or bands that a particular Transducer is designed to accept, and the anticipated application of the particular Transducer within a multi-channel system, (e.g., left front, center, right front, left rear, right rear, and sub-woofer), or the way in which the signal should be modified to suit various room or outdoor characteristics.

Each dataset contained in an individual TSF may be specified by an identifier under some naming scheme. Thus, for example, the name “TSF 1” may uniquely specify the TSF associated with one type or class of Transducer, while the name “TSF 2” may uniquely specify the TSF associated with another, different, type or class of Transducer. Such an identifier under such a naming schema is used hereinafter to refer to as a “TSF Identifier” or as a “TSF ID.”

An exemplary TSF is shown in Table 1 below.

TABLE I
Passive or Active status: Active = 1, Passive = 0
Number of driver Transducers (number of ‘ways’): 1 to 6
Passive: correction filter set. e.g. DEQX proprietary calibration template
(DEQX-CalT)
Driver 1 filter set (low bass): e.g., DEQX-CalT including LowPass
crossover filter
Driver 2 filter set: e.g., DEQX-CalT including LowPass/HighPass
crossover filters
Driver 3 filter set: e.g., DEQX-CalT including LowPass/HighPass
crossover filters
Driver 4 filter set: e.g., DEQX-CalT including LowPass/HighPass
crossover filters
Driver 5 filter set: e.g., DEQX-CalT including LowPass/HighPass
crossover filters
Driver 6 filter set (high highs): DEQX-CalT including HighPass
crossover filter

In the exemplary TSF of Table 1, data as to whether a Transducer is Active or Passive is included. Also, for multi driver (i.e., “composite”) Transducer systems, the number of individual drivers included in the composite Transducer is also included. It will be recognized by those of skill in the art that while Table II shows filter sets for six drivers, Table II may, of course, be expanded any number of additional drivers. Consequently, the invention is not considered to the six-driver configuration chosen for purposes of disclosure. Rather and number of drivers may be included and are considered to be included within the scope of the invention.

The DEQX proprietary calibration template (DEQXCalT) for the Transducer system, whether for a single Transducer or a composite Transducer system, is also identified.

For composite Transducer systems, in the exemplary TSF, up to six additional rows are provided to identify the proprietary calibration templates for each component Transducer of the composite Transducer system.

As previously mentioned each TSF has a matching TSF ID associated therewith. An exemplary TSF ID is shown in Table II below.

TABLE II

| | |
|---|---|
| Country of manufacture: | XXXX XXXX |
| Manufacturer ID: | XXXX |
| Class ID: | XXXX |
| Model ID: | XXXX XXXX |
| Serial # (optional): | XXXXXXX |

For the most part, the exemplary TSF ID of Table II is considered to be self explanatory. The Class ID identifies the potentially large class of Transducers to which the Transducer being identified belongs. The optional Serial # identifies a unique specimen of the indicated manufacturer and indicated model number from the manufacturer. To reiterate, the Transducer correction may be performed at various levels of precision. To do the least precise correction, the data from the DEQXCalT associated with the class ID may be utilized. To do a more precise correction, the DEQXCalT associated with the manufacturer and model number may be utilized. To do the most precise correction, the DEQXCalT associated with the serial number of the Transducer may be utilized.

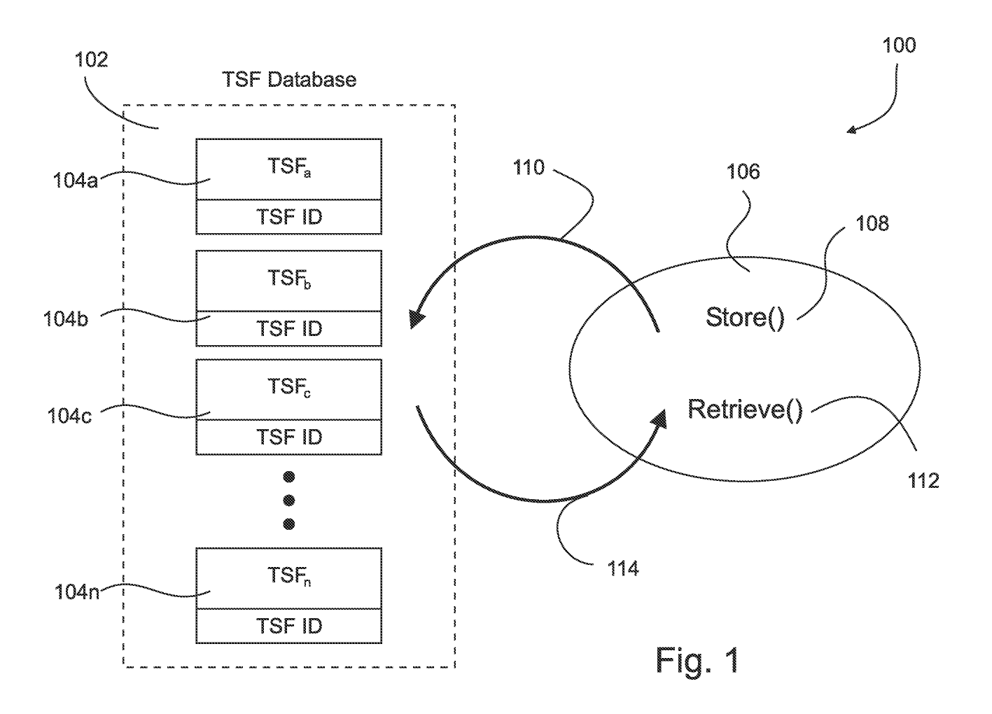

Referring now to FIG. 1, there is shown a simplified block diagram of a TSF database and Store( ) and Retrieve( ) processes, generally at reference number 100.

TSF Database 102 contains a plurality of TSF/TSF ID pairs, 104a, 104b, 104c . . . 104n.

The Transducer Interface Module (TIM) is shown schematically at reference number 106 and contains at least two methods: Store( ) 108 and Retrieve( ) 112. Access system 106 interacts as shown schematically at arrows 110, 114, respectively. Such access arrangements and the schematic representation of processes (e.g., Store( ) 108 and Retrieve( ) 112 are believed to be known to persons of skill and, consequently, are not further described or discussed herein.

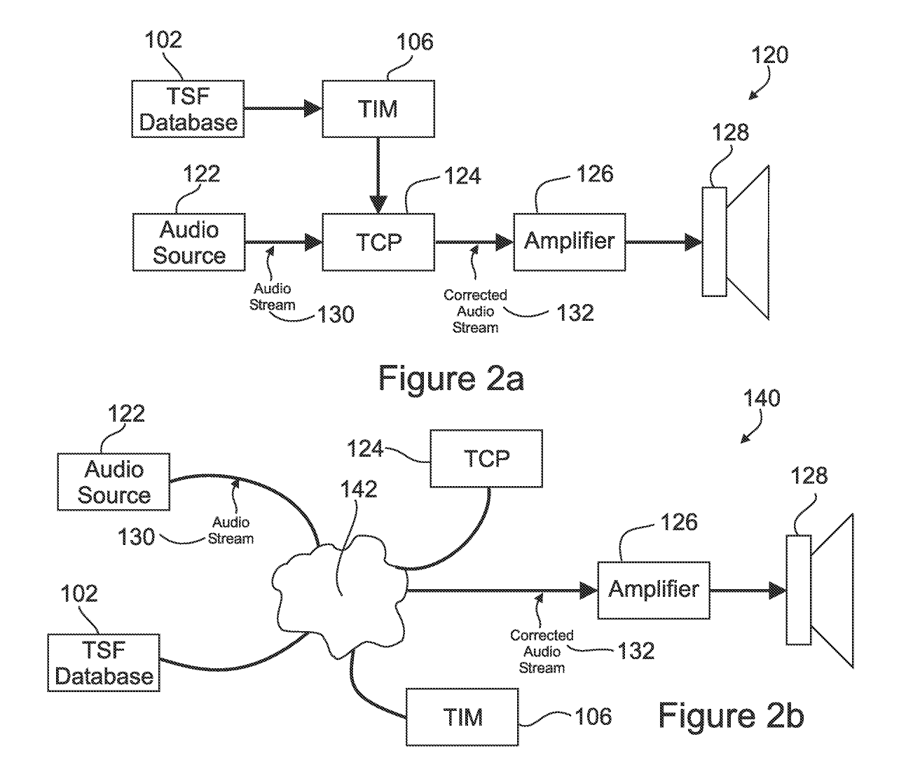

Referring now also to FIGS. 2a and 2b, there are shown simplified system block diagrams of two embodiments of a high definition audio apparatus, generally at reference number 120 and 140, respectively. As used herein, the term high definition audio apparatus is used to refer to a system having: one or more Audio Sources 122; one or more TCP elements 124; one or more Active or Passive Transducer elements 128; one or more TSF database elements 102; and one or more TSF interface managers (TIM) 106, functionally interconnected. The interconnection may be by point-to-point (P2P) connection, a LAN Connection, or a WAN Connection.

Once so connected, these elements of the high definition audio apparatus may exchange information. For example, a TCP 124 in the high definition audio apparatus can accept, and use for its own configuration, one or more TSF files 102a, 102b, 102c . . . 102n from a TSF Database 102 in the high definition audio apparatus 100. Also, a TCP 124 in the high definition audio apparatus has the ability to accept an audio stream 130 (FIGS. 2a and 2b) from an Audio Source in the high definition audio apparatus and using information from the TSF file 102a, 102b, 102c . . . 102n, create a corrected audio stream 132 (FIGS. 2a and 2b); and a TCP 124 in the high definition audio apparatus 100, and/or an Audio Source in the high definition audio apparatus, can transmit a corrected audio stream to a Transducer in the high definition audio apparatus.

FIG. 2a is simplified system block diagram of a high definition audio apparatus with system components interconnected using P2P connections.

A TSF database 102 containing a plurality of TSF/TSF ID components 104a . . . 104n is interfaced by TIM 106 as described hereinabove. The configuration from an appropriate one of TSF/TSF ID components within TSF database 102 is retrieved by TIM 106 and communicated to TCP 124 via a P2P interconnection, not specifically identified. TCP 124 receives an audio stream 130, via another P2P connection, and transforms that audio stream 130 into a corrected audio stream 132.

Corrected audio stream 132 is passed to an amplifier 126 and the amplified corrected audio stream from amplifier 126 is finally applied to Transducer 128.

Assuming that an appropriate TFS/TSF ID component 104a . . . 104n has been selected, the amplified corrected audio signal 132 applied to Transducer 128 correct frequency or temporal aberrations caused by Transducer 128 and the sound emitted therefrom is corrected so as to more closely resemble sound emitted by an ideal Transducer.

In FIG. 2b there is shown an alternate embodiment of high definition audio apparatus 120, generally at reference number 140. Each of the components of high definition audio apparatus 120 are present, however, all P2P interconnections of high definition audio apparatus 120 have been replaced by a “cloud” interconnection 142. Cloud 142 is intended to schematically represent any combination of LAN or WAN connections as discussed hereinabove.

In operation of this embodiment 140, TCP 124 may accept an audio stream 130 from Audio Source 122. TCP 124 may produce a corrected audio stream 132 that is then sent back to Audio Source 122. Audio source 122 then transmits that corrected audio stream to amplifier 126 connected to Transducer 128.

It should be noted that the various components (i.e., Audio Sources, TSF databases, TCPs, TIMs, etc. of a high definition audio apparatus such as those shown in FIGS. 2a and 2b may be arranged and integrated in myriad ways. Consequently, the invention is intended to include any and all ways of combining the functions with one another, interconnecting the components using any combination of P2P or LAN/WAN interconnections. Consequently, the invention is not considered limited to the examples chosen for purposes of disclosure.

For example, in one embodiment the functions of TCP 124, TSF database 102, and Audio Source 122 may be combined into a single device. In another embodiment, the TSF Database 102 for the high definition audio apparatus may be contained on/in a separate storage device, not shown, and accessed as required over a LAN or WAN connection.

An exemplary embodiment of an integrated high definition audio apparatus is now described. As previously stated, in many embodiments of high definition audio apparatus, the functions of multiple high definition audio apparatus components may be combined to create a single integrated high definition audio system. One example of such a system might include:
One or more Audio Sources 122 that can be selected for playback by user;
Multiple Transducers, not specifically identified, that are designed to be used together to provide stereo or multi-channel, full spectrum, audio reproduction; and
One or more TCPs 124 able to create all of the corrected audio streams necessary to drive each of those Transducers.

In accordance with the system and methods of the invention, the high definition audio apparatus discussed above may retrieve one or more appropriate TSFs matching one or more Transducers forming part of the high definition audio apparatus. Retrieval of one or more TSFs is necessary before a TCP within that high definition audio apparatus can produce a corrected audio stream appropriate for an individual Transducer forming part of the high definition audio apparatus.

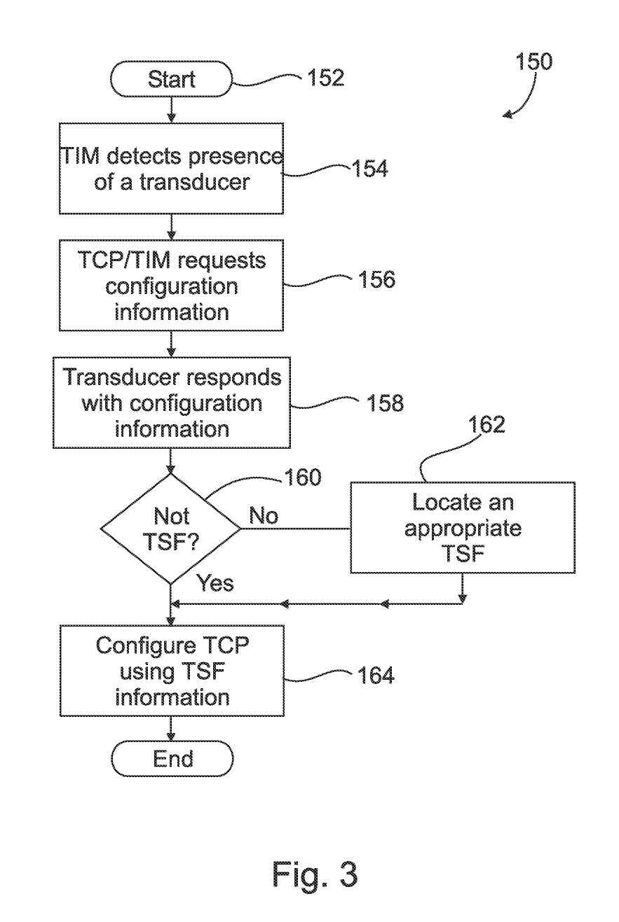

Referring now to FIG. 3, there is shown a simplified flowchart illustrating the steps of an exemplary method in accordance with the invention, generally at reference number 150.

The process starts, block 152.

The TCP, alone or in cooperation with a TIM, (hereinafter, the “TCP/TIM”) detects the presence of an audio Transducer in the high definition audio apparatus, block 154.

That TCP/TIM then communicates with a TIM associated with that Transducer (hereinafter, a “Transducer TIM”) to request configuration information, block 156.

The Transducer TIM responds by sending back configuration information, block 158. That information provided by the Transducer TIM may be in one or more of several forms and may include: A Transducer Specification File; a TSF ID; or identification information sufficient to allow retrieval of a TSF or a TSF ID (e.g., a manufacturer name and model number)

If the information transmitted is not the TSF itself, block 160, then the TCP/TIM uses the information that was supplied to retrieve the TSF, block 162. That selection may be accomplished in several ways: if a TSF ID was transmitted, then the TCP/TIM may interrogate the TSF Database using that ID to retrieve the appropriate TSF.

Alternatively, if a manufacturer's name and model number was supplied, then the TCP/TIM may interrogate a source outside the high definition audio apparatus in order to be able to find the TSF ID for that device. Once found, the corresponding TSF may be retrieved from the TSF Database.

In an alternative method for such retrieval, the Transducer TIM may proactively announce its presence within the high definition audio apparatus, rather than waiting for a request from a TCP/TIM.

Once the TCP/TIM has retrieved the TSF associated with a specific Transducer, the TIM can use the data contained in the TSF to configure the TCP such that it can create the corrected audio stream appropriate for that Transducer, block 164.

Once the configuration of the TCP is complete, the process ends, block 164.

In a first method of retrieval, the TCP/TIM communicates with the TCP to transmit the necessary configuration information for that Transducer. In an alternate retrieval method, the TCP/TIM may directly manipulate the configuration parameters of the TCP as appropriate for that Transducer.

Where more than one high definition audio apparatus been combined together into an integrated high definition audio system, each individual high definition audio apparatus within that integrated system may coordinate amongst themselves to provide configuration for the system as a whole.

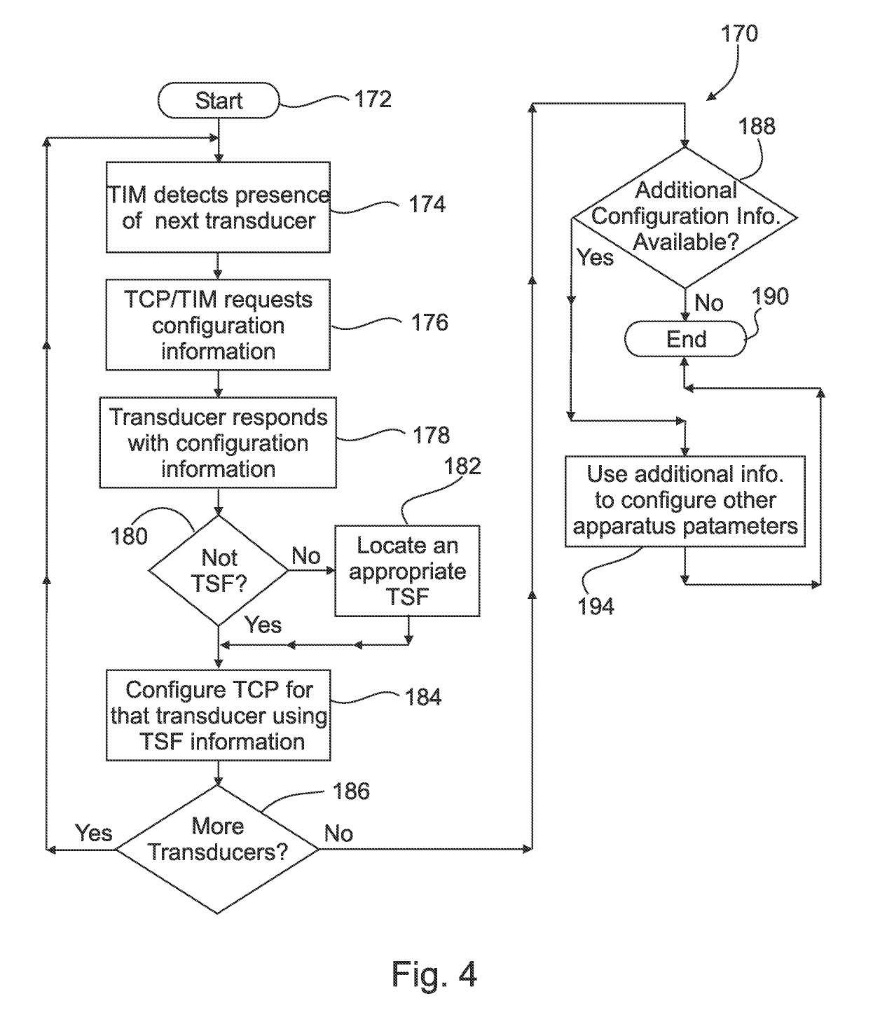

Referring now to FIG. 4, there is shown a simplified flowchart of the process for configuring a high definition audio apparatus having multiple Transducers, generally at reference number 170. The method 170 of FIG. 4 is similar to that of method 150 of FIG. 3 but an iterative step is added to process each Transducer in the high definition audio apparatus.

The process is started, block 172.

The TCP/TIM detects the presence of the next audio Transducer in the high definition audio apparatus, block 174. It is assumed that the process starts with the first Transducer and reiterates until the nth Transducer has been processed.

That TCP/TIM then communicates with the Transducer TIM associated with that Transducer being “processed” to request configuration information, block 176.

The Transducer TIM corresponding to the Transducer being processed responds by sending back configuration information, block 178. As discussed hereinabove, that information provided by the Transducer TIM may be in one or more of several forms.

If the information transmitted is not the TSF itself, block 180, then the TCP/TIM uses the information that was supplied to retrieve the TSF, block 182. Any of the ways previously discussed may be used.

Alternatively, if a manufacturer name and model number was supplied for the Transducer being processed, then the TCP/TIM may interrogate a source outside the high definition audio apparatus in order to find the TSF ID for that device. Once found, the corresponding TSF may be retrieved from the TSF Database.

In an alternative method for such retrieval, the Transducer TIM may proactively announce its presence within the high definition audio apparatus, rather than waiting for a request from a TCP/TIM.

Once the TCP/TIM has retrieved the TSF associated with Transducer being processed, the TIM can use the data contained in the TSF to configure the TCP such that it can create the corrected audio stream appropriate for that Transducer, block 184.

When configuration of the TCP for the Transducer has been completed, control passes to decision block 186. If there are additional Transducers that require configuration, control passes to block 174.

If the Transducer being processed is the last Transducer in the high definition audio apparatus, block 186, control is transferred to block 194.

Otherwise, control is returned to block 174 and the process continues until all Transducers associated with the high definition audio apparatus have been processed and all associated TCPs have been configured.

If the last Transducer has been processed, block 186, a check is made for the availability of additional configuration information, block 188. If additional configuration information is available, block 188, the information is used to do additional system configuration, block 194. When the additional configuration block 194 is complete, the process ends, block 190. Such additional information may be used for such purposes as routing a corrected audio stream for the left channel to the left channel Transducer and a corrected audio stream for the right channel to the right channel Transducer, and other similar purposes. It will be recognized by those of skill in that art that numerous other configuration tasks could be accomplished based upon additional configuration data contained in one or more TSFs. Consequently, the invention is not considered limited to the additional configuration task chosen for purposes of disclosure. Rather the invention is intended to include any and all additional configurations.

If no additional configuration is available, block 188, the process ends, block 190.

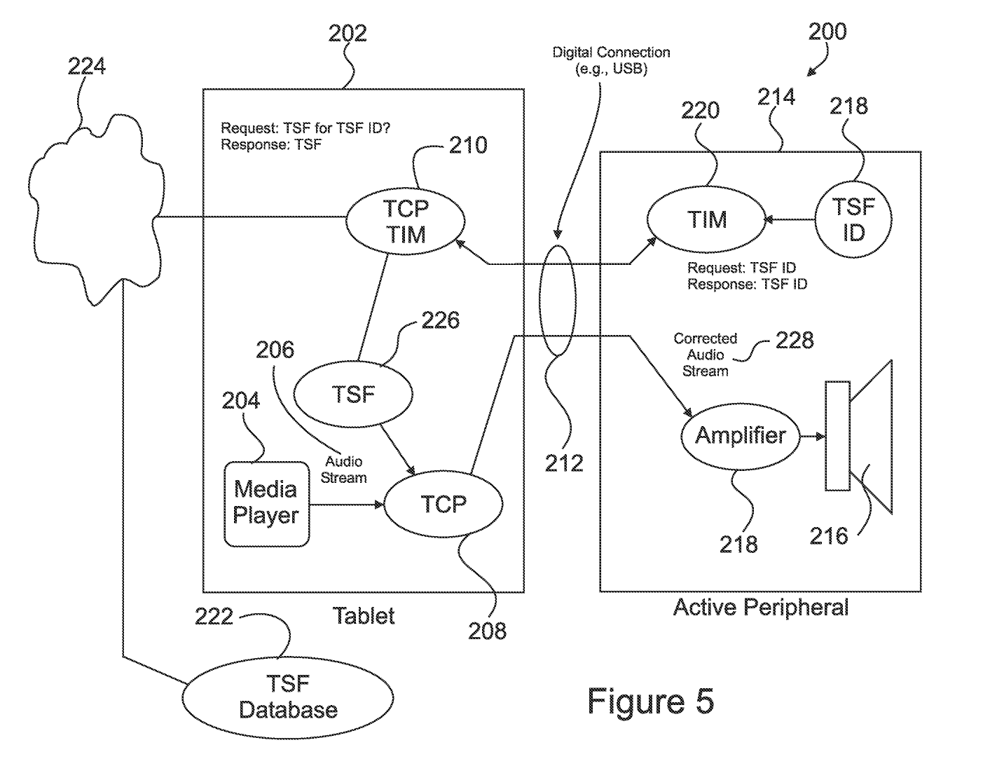

Referring now also to FIG. 5, there is shown a system block diagram of a standards-based high-definition audio ‘active’ peripheral interface in accordance with the invention, generally at reference number 200. Exemplary high definition audio apparatus 200 is implemented as part of a digital device such as a so-called “smart” phone, a tablet computer, a game console, or any other similar electronic device, known or yet to be designed. For purposes of disclosure, a tablet computer has been chosen and designated a source device 202.

Source device 202 contains an audio signal source, for example, media player 204. It will be recognized that any source of an audio stream 206 may be substituted for media player 204 and, consequently, the invention is not considered limited to any particular audio signal source within or external to source device 202.

A TCP 208 and a TIM 210 are implemented using the tablet's general purpose processor, not shown, in source device 202 executing appropriate software.

A digital communications connection 212 is provided based on a standard connection such as a USB interface that allows the TCP and TCP TIM to connect to a compatible Active Transducer 214. It will be recognized that any wired or wireless connection may be utilized to implement digital interface 212.

Active Transducer 214 may be, for example, a powered full-range loudspeaker system. Active Transducer 214 contains a Transducer 216 powered by an amplifier 218. Active Transducer 214 has embedded as TSF ID 218 that is accessed and communicated by TIM 220 via digital interface 212.

TSF ID 218 is communicated to TCP TIM 210 via TIM 220 and digital interface 212. TCP TIM 210 in turn queries TSF Database 222 via a LAN/WAN connection shown schematically as cloud 224 using methods previously described.

TCP TIM 210 retrieves an appropriate TSF 226 from TSF Database 222 assumed to be WAN-accessible. Source device 202 typically uses standard internal resources, not specifically identified, typically accessing the TSF Database 222 through a URL, not shown, maintained by a developer of the interface standard.

TSF 226 for Active Transducer 214 is used to configure TCP 208 to produce the appropriate corrected audio stream 228 for Active Transducer 214. Corrected audio stream 228 is communicated to Transducer 214 via digital interface 212.

The methods described hereinabove may be used to retrieve the TSF information for a Transducer, and to automatically configure a TCP to produce the appropriate corrected audio stream for that Transducer.

The TSF Database is stored in, and TSFs are retrieved from, a WAN-accessible location that is accessible by the exemplary high definition audio apparatus 200 through its standard capabilities e.g., through a URL maintained by the developer of the interface standard.

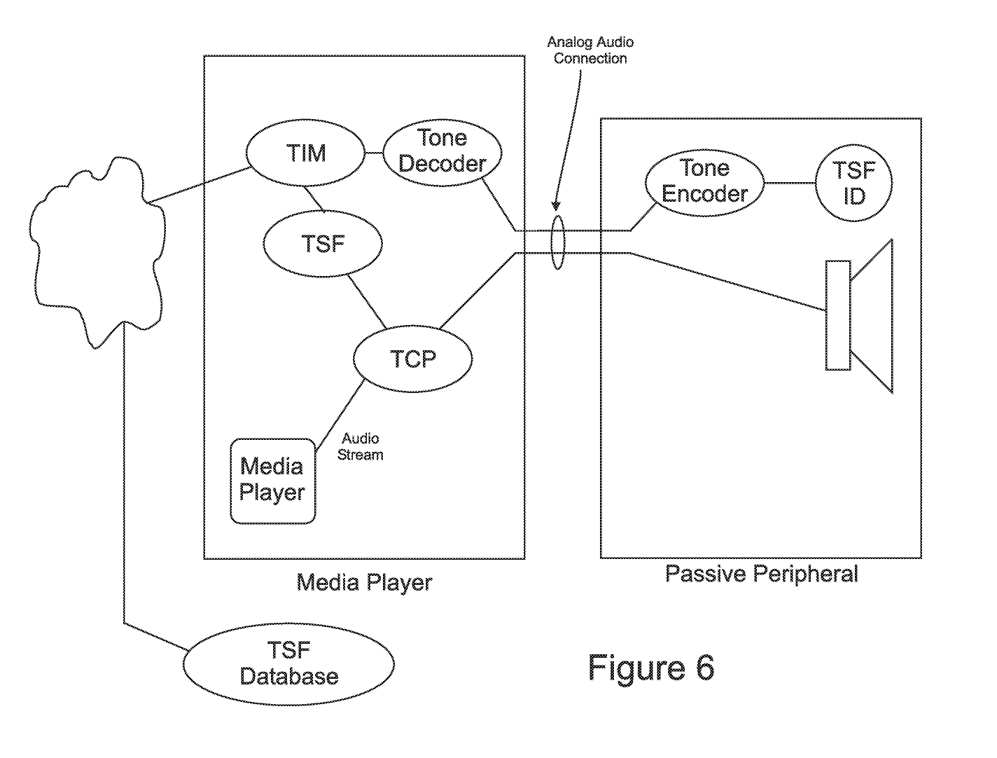

Referring now also to FIG. 6, there is shown a system block diagram of a standards-based high-definition audio “passive” peripheral interface in accordance with the invention, generally at reference number 250. Exemplary high definition audio apparatus 250 is implemented as part of a standard digital player such as a so-called “smart” phone, a tablet computer, a game console, or any other similar electronic device, known or yet to be designed. For purposes of disclosure, a media player has been chosen and designated a source device 252.

In high definition audio apparatus 250, the digital interface 212 between source device 202 and Active Transducer 214 of high definition audio apparatus 200 is replaced by an analog interface, 254 and the Active Transducer 214 is replaced by a Passive Transducer 256.

Source device 252 contains an audio signal source, for example, media player 258. It will be recognized that any source of an audio stream 260 may be substituted for media player 258 and, consequently, the invention is not considered limited to any particular audio signal source within or external to source device 252.

A TCP 264 and a TCP TIM 262 are implemented using the general purpose processor, not shown, in source device 252 executing appropriate software.

An analog interface 254 connects source device 252 and a Passive Transducer 256. It will be recognized that any wired or wireless connection may be utilized to implement analog interface 254. In the embodiment chosen for purposes of disclosure, a standard 3 mm plug and matching socket arrangement are envisioned for such an interconnection. It will be recognized that many other compatible plug and mating sockets exist and any suitable interconnection hardware may be substituted for the 3 mm plug and socket chosen for purposes of disclosure.

An identification protocol for Transducer peripherals uses the analog interface 254 to that allows the TCP/TIM 262 to obtain sufficient data to identify the TSF ID 268 of a compatible Passive Transducer 256. Such data could be transmitted, for example, by a tone-based signaling system having a tone encoder 266 in Passive Transducer 256, activated when Passive Transducer 256 is first connected to source device 252.

Passive Transducer 256 may be, for example, a full-range loudspeaker system.

TSF ID 268 is encoded by tone encoder 266 and communicated to TCP TIM 262 across analog interface 256 to a compatible tone decoder 270. Tone decoder 270 is connected in turn to TCP/TIM 262.

TCP/TIM 262 in turn queries TSF Database 272 via a LAN/WAN connection shown schematically as cloud 274 using methods previously described.

TCP/TIM 262 retrieves an appropriate TSF 276 from TSF Database 272 assumed to be WAN-accessible. Source device 252 typically uses standard internal resources, not specifically identified, typically accessing the TSF Database 272 through a URL, not shown, in a format compatible with that specified by a developer of the interface standard.

TSF 276 for Passive Transducer 256 is used to configure TCP 264 to produce the appropriate corrected audio stream 278 that is fed to an amplifier 280 within Audio Source 252 and subsequently to Passive Transducer 256 via analog interface 254.

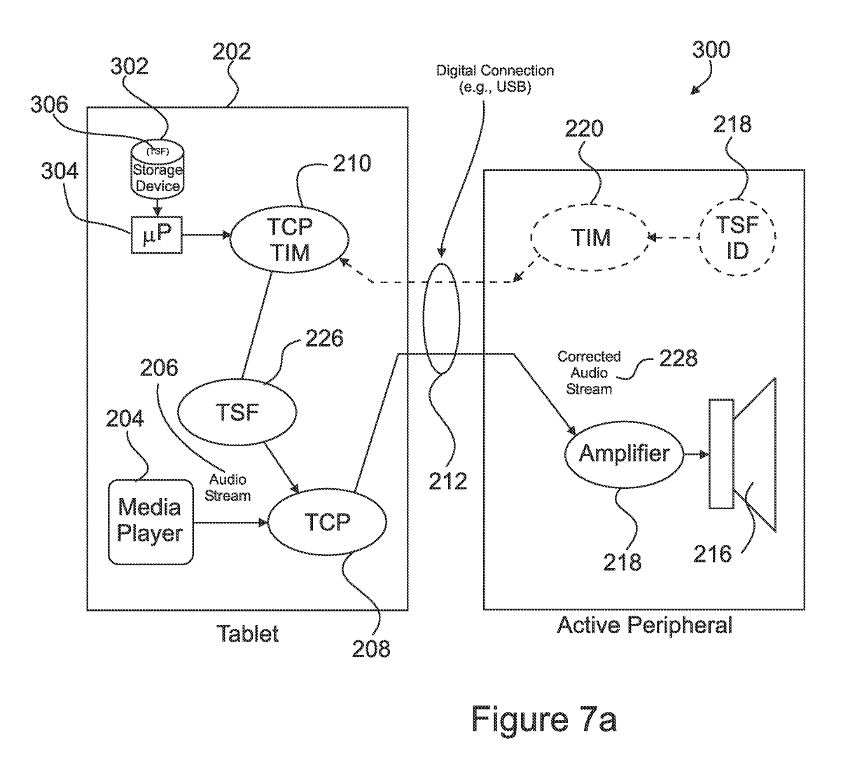

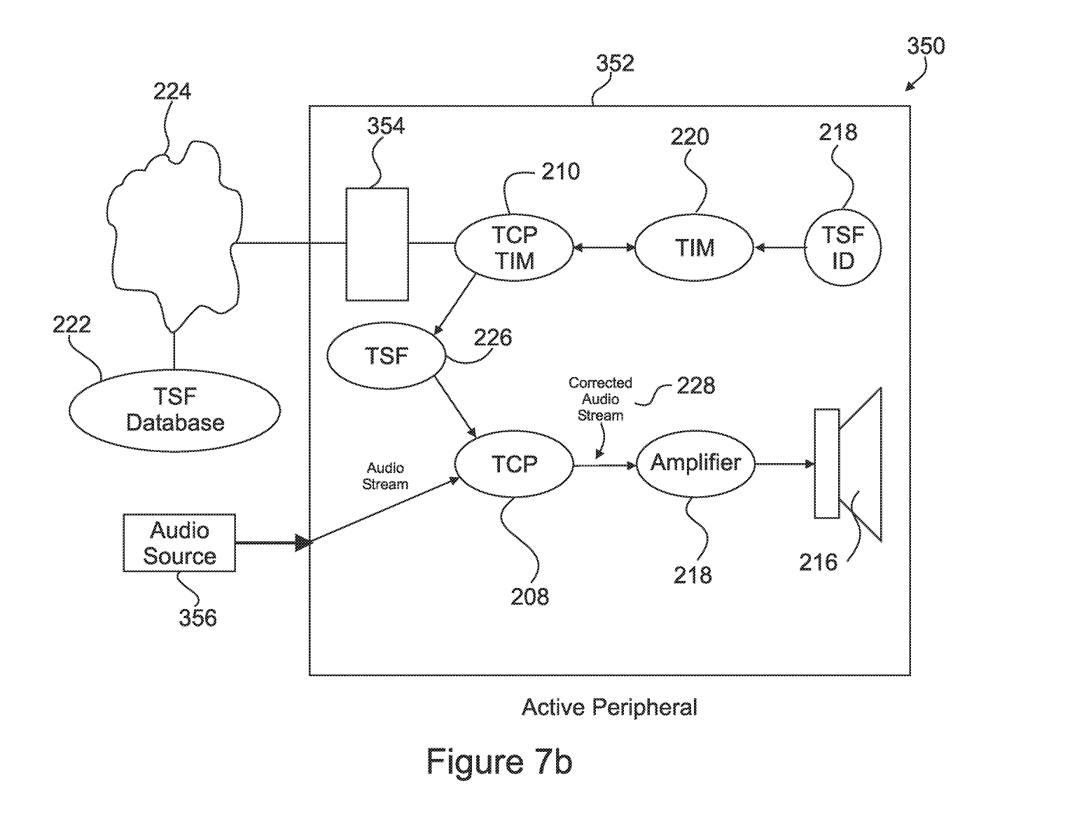

It will be recognized that the components and methods of the invention may be combined in numerous combinations. Referring now also to FIG. 7a, there is shown a simplified system block diagram of a high definition audio device including an internally stored TSF, generally at reference number 300. For example, an embodiment wherein a TSF is not retrieved from a WAN/LAN interconnection (e.g., the Internet) but rather an appropriate TSF 306 for either a particular Active or Passive Transducer is stored locally on digital storage device 302. Such digital storage device could include but are not limited to a CD or other optical media, a flash memory drive, a read-only ROM, a PROM, etc. Retrieval of the TSF 306 by the end user is accomplished using either internal electrical circuitry, for example a microprocessor (μP) 304, or using companion electronic apparatus such as a computer to transfer the TSF 306 to the TCP TIM 210. In this arrangement, WAN/LAN interface 224 and the TSF database 222 have been eliminated.

If only a single TSF 306 for a dedicated, attached Transducer is required, TIM 220 and TSF ID 218 may also be eliminated. If, however, more than one TSF 306 is stored in storage device 302, then TIM 220 and TSF ID 218 along with the necessary digital connection 212 is still required.

In yet other embodiments of the novel system and methods of the invention, all function components of the digital signal processing system may be physically disposed within either an Active or Passive Transducer, thereby forming a self-contained high definition audio apparatus. Referring now also to FIG. 7b, there is shown such a self-contained high definition audio apparatus including an Active Transducer, generally at reference number 350.

In self-contained high definition audio apparatus 350, all components and their associated functions are identical to the components of high definition audio apparatus 200 of FIG. 5 with a few exceptions. First, all components are incorporated into a single physical entity 352. Media player 204 is removed and an external Audio Source 356 has been added. Digital connection 212 is eliminated, as all interconnections are now essentially P2P. Finally, an Internet interface 354 is included to facilitate interactions with TSF database 222.

While the apparatus and processes of the present invention have heretofore generally been regarded as having optimum use in high end, high definition audio systems, the novel apparatus and methods make possible overcoming distortions in time and/or frequency domains imparted by less-than-perfect Transducers. The result of correcting time and frequency distortion is so substantial that an unforeseen application of the apparatus and methods of the invention have been discovered. The apparatus and methods of the invention may be applied to so-called public address (PA) Transducers. PA Transducers are typically implemented as column speakers, in-wall speakers, horn speakers, or other speaker formats. Horn Transducers in particular are notorious introducers of distortion into an audio system. Horn Transducers are typically constructed primarily from metal or polymeric materials and are, therefore, substantially weatherproof. The audio performance characters of such Transducers are therefore often relegated to a lower level of importance than the physical characteristics of the devices. Creating weather proof Transducers having good auditory characteristics is difficult, and such devices are generally relatively expensive.

After applying the methods of the invention to even very inexpensive horn Transducers, the sound (i.e., the audio signal produced by the Transducers) characteristics are vastly improved. One of the greatest problems in PA installations is that numerous Transducers are placed throughout a facility and a listener is often bombarded by audio streams from multiple Transducers, further compounding the distortions inherent in PA audio systems. A result of overcoming distortions in these Transducers results in much greater overall intelligibility in the system even though multiple audio streams still arrive at a listener's ears from the multiple Transducers, with possible time-phase errors associated with differing distances of the Transducers from the position of the listeners.

Because horn Transducers are mass produced devices they may have poor but typically predictable acoustical performance. This fact often makes correcting such Transducers using the broadest defined class of correction (i.e., class correction) highly effective. Consequently, a single TSF and a single TCP may be sufficient to provide a corrected audio stream to numerous such Transducers therefrom. It will be recognized that multiple amplifiers may be required to provide adequate acoustical output signals from the corrected horn Transducers.

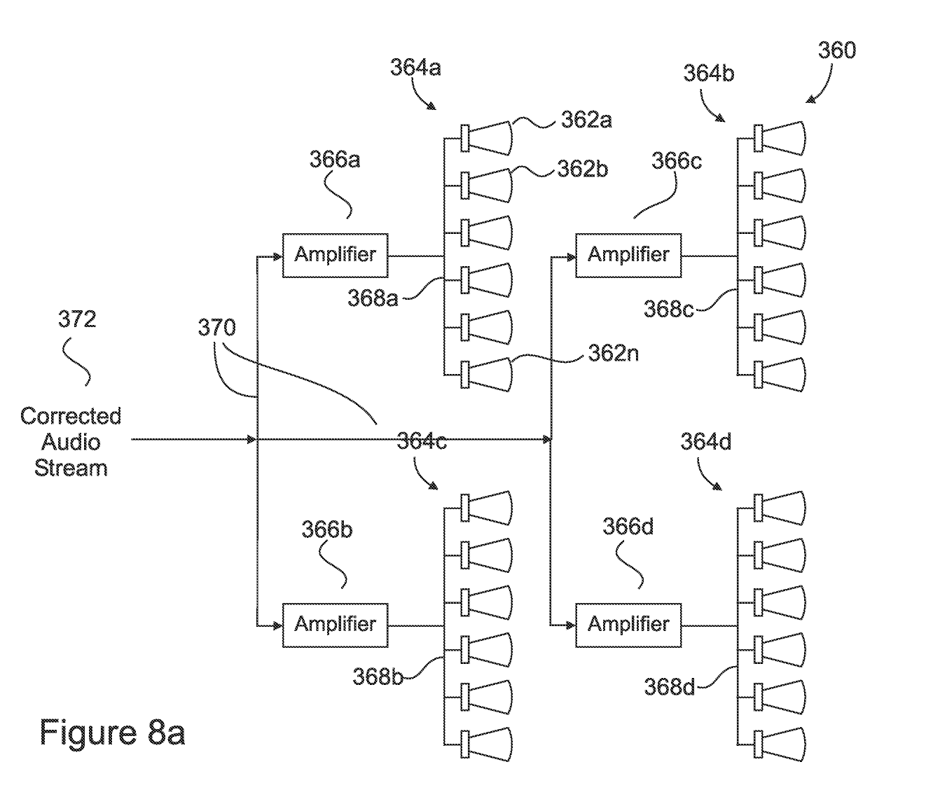

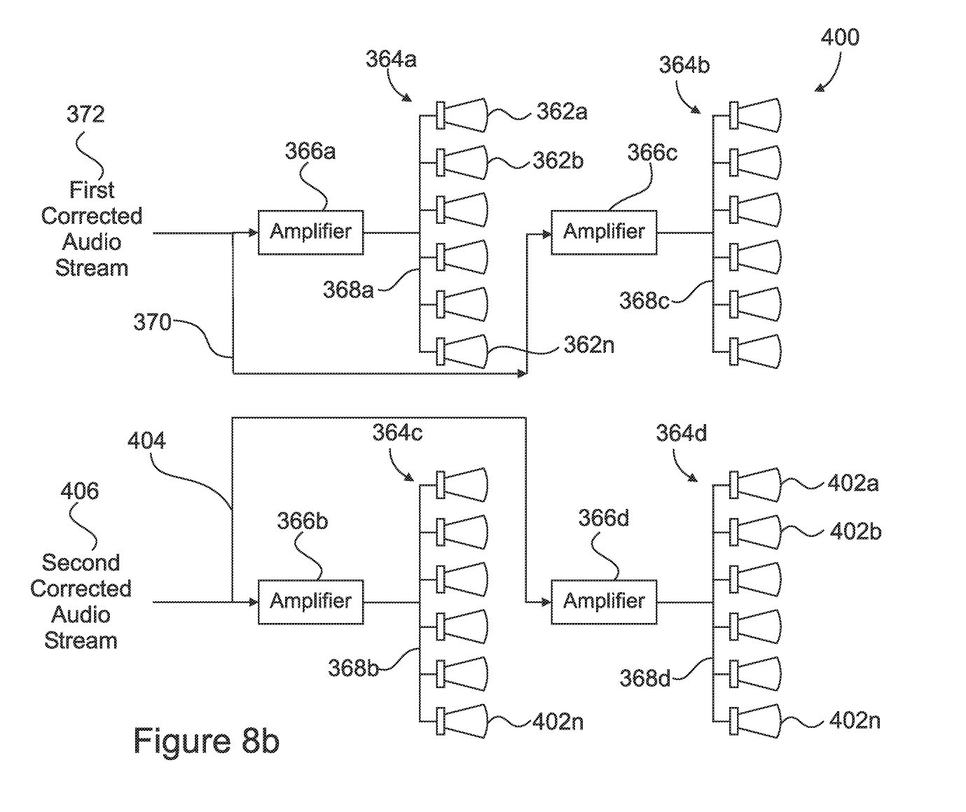

Referring now also to FIG. 8a, such an arrangement is shown at reference number 360. For purposes of disclosure, four banks 364a, 364b, 364c, 364d of Transducers 362a, 362b . . . 362n, all interconnected one to the other are connected to respective amplifiers 366a, 366b, 366c, 366d, respectively. Amplifiers 366a, 366b, 366c, 366d are commonly provided a corrected audio stream 372 by interconnection wiring 370.

In arrangement 360, it is assumed that all Transducers 362a, 362b . . . 362n have performance characteristics close enough to one another that a common TSF, not shown, is used to configure a TCP, not shown, to provide corrected audio stream 372.

It will be recognized that other elements found in public address systems and believed to be known to those of skill in the art, for example, time delay devices, none shown, may be added to arrangement 360. It will be further recognized that arrange 360 may be modified in many ways, for example, all Transducers 362a, 362b . . . 362n may be driven by a single amplifier. Further, all banks 364a, 364b, 364c, 364d need not contain an identical number of Transducers 362a, 362b . . . 362n. Many other modifications will be apparent to those of skill in the art and the invention is not considered to the particular arrangement 360 chosen for purposes of disclosure.

More typically, more than one type of Transducer may be used in a public address system. In this case, more than one processor, presumably using different TSFs is needed to feed appropriate corrected audio streams to groups of “identical” Transducers (i.e., Transducers having performance characteristic close enough to one another that a single TSF may be used to provide a corrected audio stream to each). Referring now to FIG. 8b, there is shown such an arrangement, generally at reference number 400.

The configuration 400 of FIG. 8b shows a public address system similar to that shown in FIG. 8a. However, public address system 400 shows two different types of Transducers, each type requiring a different corrected audio stream. Transducer groups 364a, 364b utilize Transducers 362a, 362b . . . 362n that are provided with a first corrected audio stream 372.

However, Transducer groups 364c, 364d consist of Transducers 402a, 402b . . . 402n driven by respective amplifiers 366b, 366d and provided with a second corrected audio stream 406 via wiring 404.

This arrangement may utilize a two-channel (“stereo”) processor, not shown, such as a product of DEQX Pty of Sydney, Australia. One channel may provide first corrected audio stream 372 while a second channel may provide second corrected audio stream 406.

Public address systems may, of course, be expanded to utilize Transducers, not specifically identified, having many different electrical characteristics, each type requiring a different corrected audio stream. It will be recognized that public address system 400 may be expanded in similar fashion to accommodate as many different Transducer types as required for a particular operating environment, each group of Transducers being supplied with an appropriate corrected audio stream.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. In a high definition audio apparatus comprising a Transducer portion and a processor portion, said processor portion comprising: a Transducer specification file (TSF) associated with said Transducer and representative of a performance characteristic thereof, a Transducer correction processor (TCP) adapted to receive an electrical signal representing an incoming audio stream, and using information from said TSF, transforming said electrical signal representing an incoming audio stream into a corrected electrical signal representing a corrected audio stream, said corrected electrical signal representing a corrected audio stream being applied to said Transducer, the improvement comprising:
said Transducer comprising a Transducer ID that may be electrically read to produce a Transducer ID signal; and wherein said Transducer ID signal may be used to automatically locate a TSF specific to said Transducer generating said Transducer ID signal, and whereby said specific TSF may be used to automatically configure said TCP expressly specifically for said Transducer generating said Transducer ID signal, said TCP subsequently providing a corrected electrical signal representing a corrected audio stream specifically corrected for said Transducer generating said Transducer ID signal.

2. The high definition audio apparatus as recited in claim 1, the improvement further comprising:
a) a TSF database comprising a plurality of TSFs including said TSF specific to said Transducer generating said Transducer ID signal and comprising a WAN/LAN interface; and
b) means for locating and retrieving said TSF specific to said Transducer generating said Transducer ID signal operatively connected to said TSF database and to said processor portion of said high definition audio apparatus.

3. The high definition audio apparatus as recited in claim 2, wherein said means for locating and retrieving at least said specific TSF comprises:
i) a WAN/LAN interface; and
ii) communications apparatus for querying said TSF database and retrieving said specific TSF using said WAN/LAN interface.

4. The high definition audio apparatus as recited in claim 3, wherein said communications apparatus for querying said TSF database and retrieving said specific TSF comprises a TSF interface module disposed in said processor portion of said high definition audio apparatus.

5. The high definition audio apparatus as recited in claim 1, wherein said specific TSF is stored within said processor portion of said high definition audio apparatus.

6. The high definition audio apparatus as recited in claim 1, wherein said corrected electrical signal representative of a corrected audio stream is communicated to said Transducer as a digital signal via a digital interface disposed between said TCP and said Transducer.

7. The high definition audio apparatus as recited in claim 6, wherein said Transducer ID signal is transmitted from said Transducer to a TCP Transducer Interface Manager (TCP TIM) in said high definition audio apparatus via a TSF Interface Manager (TIM} through said digital interface.

8. The high definition audio apparatus as recited in claim 1, wherein said corrected electrical signal representative of said corrected audio stream is communicated to said Transducer as a analog signal via an analog interface disposed between said TCP and said Transducer, and wherein said Transducer ID signal is transmitted as an analog-encoded signal from said Transducer to a decoder disposed in said processor portion of said high definition audio apparatus via said analog interface.

9. The high definition audio apparatus as recited in claim 1, wherein said specific TSF is manually input into said processor portion of said high definition audio apparatus.

10. A high definition audio apparatus, comprising:
a) a Transducer adapted to receive an audio signal;
b) a Transducer correction processor (TCP) having an output operatively connected to said Transducer and an input operatively connected to a means for receiving an incoming audio stream;
c) means for receiving an incoming audio stream operatively connected to said input of said TCP;
d) an enclosure containing said Transducer, said TCP, and means for receiving an incoming audio stream;
whereby an incoming audio stream received by said means for receiving an incoming audio stream is applied to said input of said TCP, said TCP being preconfigured by a TSF associated with said Transducer and representative of a performance characteristic thereof such that said TCP outputs a corrected audio stream at said output thereof thereby providing said corrected audio stream to said Transducer.

11. The high definition audio apparatus as recited in claim 10, further comprising:
e) means for providing a replacement TSF to said TCP to change said configuration thereof.

12. The high definition audio apparatus as recited in claim 10, further comprising:
e) means for storing a TSF operatively connected to said TCP, a TSF stored thereby being associated with said Transducer and representative of a performance characteristic thereof, said means for storing a TSF being housed within said enclosure.

13. The high definition audio apparatus as recited in claim 10, further comprising:
e) an amplifier disposed between said output of said TCP and said Transducer.

14. A high definition audio system, comprising:
a) a first plurality of Transducers, each of said first plurality of Transducers having performance characteristics that allow the use of a first Transducer specification file (TSF) to correct a first incoming stream audio stream applied to each thereof;
b) a first Transducer correction processor (TCP) having an input adapted to receive an incoming audio stream thereat and an output operatively connected to each of said first plurality of Transducers, said first TCP correcting a first incoming audio stream received at said input and transforming said first incoming audio stream into a first corrected audio stream in accordance with information contained in said first TSF;
c) at least one amplifier disposed between said output of said first TCP and each of said first plurality of Transducers.

15. The high definition audio system as recited in claim 14, further comprising:
d) a second plurality of Transducers, each of said second plurality of Transducers having performance characteristics that allows the use of second Transducer specification file (TSF) to correct a second incoming audio stream applied to each thereof, said second TSF being different than said first TSF;
e) a second Transducer correction processor (TCP) having an input adapted to receive a second audio stream thereat and an output operatively connected to each of said second plurality of Transducers, said second TCP correcting a second incoming audio stream received at said input and transforming said second incoming audio stream into a second corrected audio stream in accordance with information contained in said second TSF; and
f) at least one amplifier disposed between said output of said second TCP and each of said second plurality of Transducers.

16. The high definition audio system as recited in claim 15, wherein said first TCP and said second TCP comprises separate channels of a two channel audio signal processor.
